(19) United States
(12) Patent Application Publication
(10) Pub. No.: US 2010/0315487 A1
(43) Pub. Date: Dec. 16, 2010

(54) MEDICAL IMAGING METHOD IN WHICH VIEWS CORRESPONDING TO 3D IMAGES ARE SUPERIMPOSED OVER 2D IMAGES

(76) Inventors: Florence Grassin, Auffargis (FR); Yves Trousset, Palaison (FR); Elisabeth Soubelet, New Delhi (IN); Cyril Riddell, Paris (FR); Andras Lasso, Ontario (CA)

Correspondence Address: General Electric Company;GE Global Patent Operation, 2 Corporate Drive, Suite 648, Shelton, CT, 06484, US

(21) Appl. No.: 12/813,092

(22) Filed: Jun. 10, 2010

(30) Foreign Application Priority Data
Jun. 12, 2009 (FR) 0953952

(51) Int. Cl. H04N 13/02; G06T 15/00

(52) U.S. Cl. 348/43; 345/427; 348/E13.074

(57) ABSTRACT

A method using an imaging device to define an acquisition geometry for 2D images of an observation region, a region for which there exists a 3D representation. 2D views of the 3D representation can be determined following the acquisition geometry of the imaging device for a plurality of viewing points, so that each acquired 2D image can be superimposed with any of this plurality of views. As a variant, in the 3D representation two views are determined corresponding to the viewing point at which the eye is positioned at the formation plane of the acquired image (front view and corresponds to the 2D image) and to the viewing point at which the eye is positioned at the focal point of the projective geometry (back view which is opposite to the viewing point of the 2D image). These two views allow the generation of two images for superimposition over the acquired image, defining superimposition of the acquired image with a front view of the 3D representation of the observation region and superimposition of the acquired image with a back view of the 3D representation of the observation region.

### CROSS-REFERENCE TO RELATED APPLICATIONS

This application claims priority under 35 U.S.C. §119(a)-(d) or (f) to prior-filed, co-pending French patent application number 0953952, filed on Jun. 12, 2009, which is hereby incorporated by reference in its entirety.

### STATEMENT REGARDING FEDERALLY SPONSORED RESEARCH OR DEVELOPMENT

Not Applicable

### NAMES OF PARTIES TO A JOINT RESEARCH AGREEMENT

Not Applicable

### REFERENCE TO A SEQUENCE LISTING, A TABLE, OR COMPUTER PROGRAM LISTING APPENDIX SUBMITTED ON COMPACT DISC

Not Applicable

### BACKGROUND OF THE INVENTION

1. Field of the Invention

The present invention relates to imaging.

It more particularly concerns imaging methods in which views corresponding to 3D representations of an observation region are superimposed over 2D images of the same observation region.

2. Description of Related Art

Fluoroscopy techniques are conventionally used in interventional radiology in particular to allow real-time viewing, during a procedure, of 2D fluoroscopic images of the region in which the procedure is being carried out. The surgeon is therefore able to take bearings for navigation in vascular structures and to check the positioning of instruments and their deployment.

With the so-called 3D Augmented Fluoroscopy technique or “3DAF” this information is completed by superimposing, over the 2D image, a 2D view of a previously acquired 3D image of the observation region containing the structure or organ in which procedure is being conducted.

Under the present invention, “2D view” means a representation in a plane of a 3D representation.

This 2D view is calculated for this purpose so that it corresponds to the same acquisition geometry as defined by the 2D fluoroscopic image over which it is superimposed. One example of this type of processing is notably described in the patent application “Method and apparatus for acquisition geometry of an imaging system” (US 2007-0172033).

The information given to the practitioner by this superimposed display remains limited however, since the 2D view is calculated for only one acquisition geometry i.e. that of the 2D fluoroscopic image.

### BRIEF SUMMARY OF THE INVENTION

The present invention concerns a medical imaging method using at least one 2D image of a patient's observation region acquired by an imaging device defining an acquisition geometry, a region for which there exists a 3D representation, characterized in that the method comprises the determination of at least 2D views of the 3D representation following the acquisition geometry of the imaging device for at least two different viewing points of the observation region, so as to allow the superimposition of the 2D image with each 2D view.

If the view is a volume view entailing management of hidden parts, the information given is different and complementary since if part A hides part B for one viewing point, part B will hide part A for the opposite viewing point.

This then provides the practitioner both with a front 2D view and a back 2D view of the parts of the structure or organ, without it being necessary to change the viewing angle and hence the acquisition geometry of the fluoroscopic 2D image.

Preferred, but non-limiting, aspects of the method of the invention are the following:
the 2D image is acquired by placing said region between a source and a receiver, the first viewing point of the observation region being located on the source side and the second viewing point of the observation region being located on the receiver side,
the imaging device defines a conical acquisition geometry, having an axis of revolution, the first viewing point of the observation region being positioned on the axis of revolution at the plane at which the 2D image is formed, and the second viewing point of the observation region being located on the axis of revolution at the focal point of the projective geometry,
the method further comprises the generating of at least two superimposition images, each thereof corresponding to the superimposition of a respective 2D view of the 3D representation over the 2D image.

In one embodiment for example, the images being acquired using apparatus with a conical radiation source:

A geometric conversion matrix is applied to the previously acquired original 3D representation, such that all the rays leaving the focal point of the source and passing through the 3D representation following the acquisition geometry before conversion are parallel after conversion.

And in the converted 3D representation, a view is determined following a parallel viewing geometry, equivalent to the acquisition geometry in the original 3D representation, and from a viewing point at which the depth is defined from the image formation plane of the acquisition geometry (front view).

Under another embodiment:
In the 3D representation a view is determined following the acquisition geometry of the 2D image, and the back view is thereby obtained. To obtain the front view i.e. from a viewing point at which depth is defined from the image plane, the values entered into the buffer depth memory are inverted.

If the focal point is infinity, the case is the simple case in which the acquisition geometry is parallel and in which geometric conversion of the 3D representation is identical.

The invention also concerns a medical imaging system comprising an imaging device defining an acquisition geometry and allowing the acquisition of at least one 2D image of an observation region in a patient, a region for which there exists a 3D representation, noteworthy in that the system comprises means to determine at least two 2D views of the 3D representation following the acquisition geometry of the imaging device for at least two different viewing points of the observation region, so as to allow superimposition of the 2D image with each 2D view.

The invention also concerns a medical imaging system comprising a radiation source and an acquisition sensor of 2D images, at least one memory to store at least one previously acquired 3D image, a processing unit which determines a front view in said 3D image from a same viewing angle as for the 2D image, a display screen on which said processing unit displays the superimposition of said 2D image and said front view, the system being noteworthy in that said processing unit further determines a back view in said 3D representation said view being superimposable over the 2D image.

The invention also concerns a computer programme product comprising programming instructions able to determine a back view in a 3D image, the back view being from the same viewing angle as the 2D image, characterized in that the programming instructions, in said 3D image, are also able to determine a front view of said 3D image, and to display a superimposition of the front view and the 2D image.

### BRIEF DESCRIPTION OF THE SEVERAL VIEWS OF THE DRAWINGS

Other characteristics and advantages of the invention will become further apparent from the follow description which is solely illustrative and is non-limiting, and is to be read with reference to the appended figures in which:

FIG. 1 illustrates exemplary apparatus conforming to a possible embodiment of the invention;

FIGS. 2A and 2B illustrate two possible embodiments for a method conforming to the invention;

FIG. 3 schematically illustrates geometric conversion due to the conical shape of radiation, and the position of a viewing point that is inverted relative to the viewing point of the source;

FIGS. 4a and 4b are examples of anterior (or front) images and posterior (or back) images obtained using a method according to FIG. 2a or 2b (views without translucency of the 3D representation);

FIGS. 5a and 5b are examples of front and back views obtained using a method according to FIG. 2A or 2B (views with translucency of the 3D representation).

### DETAILED DESCRIPTION OF THE INVENTION

### General

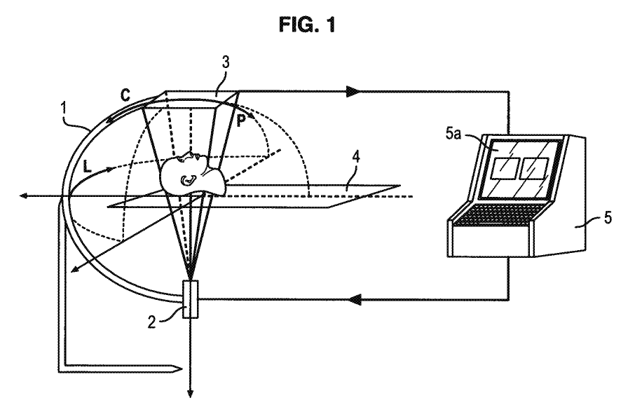

The apparatus shown in FIG. 1 comprises a C-arm (1) which, at one of its ends, carries a radiation source (2) and at its other end a sensor (3).

As is conventional, the C-arm is able to be pivoted about the axis of a table (4) intended to receive the patient to be imaged, and to be moved relative to this table 4 in different directions schematized by the double arrows in the figure, so as to allow adjustment of the positioning of said arm relative to that part of the patient that is to be imaged.

The source (2) is an X-ray source for example. It projects conical radiation which is received by the sensor (3) after passing through the patient to be imaged. The sensor (3) is of matrix array type and for this purpose comprises an array (3) of detectors.

The output signals from the detectors of the array (3) are digitized and they are received and processed by a processing unit (5) which optionally stores in memory the digital 2D images thus obtained. Before and after processing, the digital 2D images thus obtained can also be memorized separately from the processing unit (5), any medium possibly being used for this purpose: CD-ROM, USB key, mainframe memory, etc.

As is conventional for example, prior to the procedure a set of 2D images is acquired of the patient organ on which procedure is to be performed by rotating the C-arm around the patient. The set of 2D images obtained is then processed to calculate a 3D representation of the organ concerned by procedure. Processing operations to isolate a given organ and to determine a 3D representation from a set of 2D images are conventionally known per se.

Display of a 2D view of the 3D representation is then made using a given viewing geometry containing a viewing angle direction z, a direction orthogonal to the plane of formation of the 2D view and whose origin defines the viewing point. Direction z therefore defines a depth relative to the viewing point such that the foreground planes are defined for z values close to 0 and the more distant planes by z's of higher value. The 3D representation points which correspond to the x, y coordinates in the formation plane of the 2D view orthogonal to the viewing direction z are projected in relation to their depth z in said direction. For this purpose, for each coordinate point x, y of the 2D view to be displayed a buffer depth memory is formed in which the voxels of the 3D representation are memorized in relation to their depth z. This buffer depth memory is itself processed so that the displayed 2D view shows those parts of the 2D view which are in the foreground and does not show the hidden parts (background). Said processing is conventionally known per se.

The 2D view of the 3D representation can be displayed superimposed over a 2D image whose acquisition geometry is known, for example a fluoroscopic image acquired in real-time during a procedure. One example of such processing is notably described in the patent “Method for the improved display of co-registered 2D-3D images in medical imaging” (US 2007/0025605).

### Processing and Display

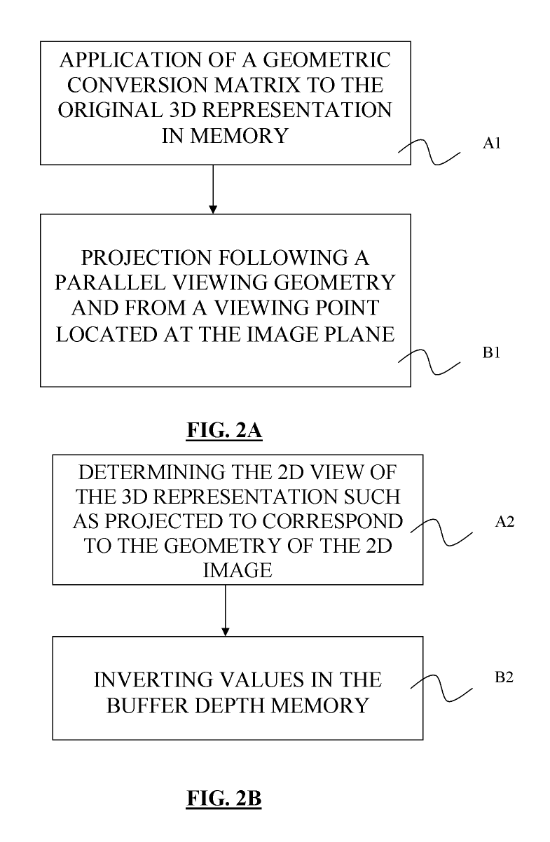

As illustrated in FIG. 2A, the following processing is carried out on 3D representations.

During a first step (A1) a geometric conversion matrix is applied to the original 3D representation in memory, this matrix intended to allow viewing in parallel geometry equivalent to viewing using the conical acquisition geometry of the radiation of source (2) for the original 3D representation.

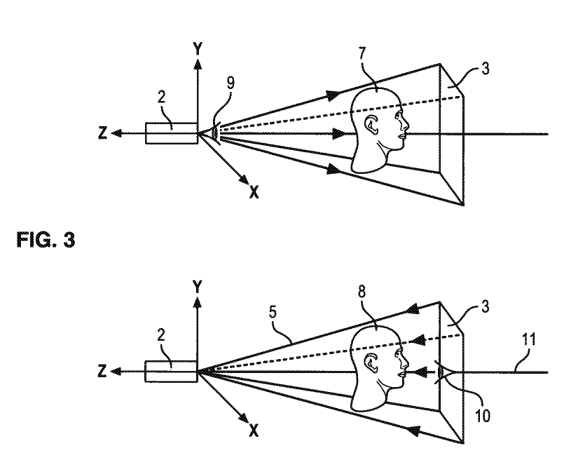

As effectively illustrated in FIG. 3, it will be appreciated that on account of the conical shape 6 of the radiation of source (2), the projection of that part of the organ close to the focal point which it is desired to view on the plane of the sensor (3) is subject to homothetic distortion compared with the projection of that part close to the detector (3). If this distortion is applied with the geometric conversion matrix, viewing can be obtained in parallel geometry in the converted representation.

During a second step (B1), the value of a point is determined in the 2D view which it is desired to display by projecting in parallel from a back viewing point (FIG. 3) the reverse of the front viewing point of the acquired 2D image (viewing point at 180° relative to that of the acquired 2D image—FIG. 3).

Another manner of proceeding, illustrated FIG. 2B, consists of determining A2 the 2D view of the 3D representation such as projected to correspond to the geometry of the 2D image whilst, B2, inverting the coordinates of the buffer depth memories, so as to reverse the viewing point 9, 10 and thereby obtain a front 2D view (7) which can be superimposed over the 2D image.

Both manners of proceeding are equivalent and in both cases allow a front 2D view (7) of the 3D representation to be obtained which, as is usual for the back 2D view (8), can be displayed by being superimposed over the fluoroscopic 2D image.

This therefore provides the practitioner with two 2D views (7, 8) superimposed over the fluoroscopic 2D view: one a front view (7), the other a back view (8) of the organ on which procedure is being performed.

These two 2D views of the 3D representation, which are superimposed over the fluoroscopic 2D image, can be displayed successively or simultaneously on the display screen, one beside the other.

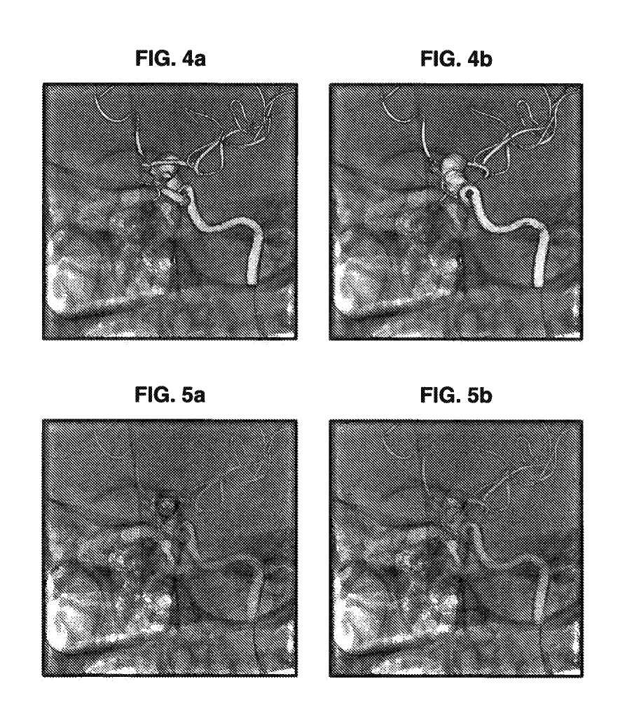

Examples of front and back 2D views 7, 8 obtained in this manner are given in FIGS. 4a and 4b (2D views without translucency), and 5a and 5b (2D views with translucency).

It will be appreciated that said display of 2D views of the 3D representation corresponding to front and back 2D views provides practitioners with better perception of their surgical movements.

As an example, when treating multilobar intercranial aneurysms, the lobes can be viewed on either side of the head for better apprehending of the aneurysm being treated.

Additionally, said front and back display has the advantage of helping the practitioner to solve some positioning ambiguities of instruments. For example, in electrophysiology, by being able to view the catheter tip from two different 2D views, the surgeon is able to better identify the heart area where the instrument is positioned.

As will be understood, the processing just described is performed digitally, by unit 5 for example, the results being displayed on a display screen 5a of said unit. The programming instructions corresponding to this processing can be memorized in dead memories of unit 5 or in any suitable data processing medium: CD-ROM, USB key, memory of a remote server, etc.

What is claimed is:

1. An imaging method that utilizes at least one 2D image of at least an observation region of an object, wherein there exists a 3D representation of the observation region stored in at least one memory unit and wherein the 2D image is acquired by an imaging device, said method comprising:
defining an acquisition geometry of the observation region based upon a viewing angle of the imaging device;
defining at least two viewing points of the observation region;
obtaining at least two 2D views of the 3D representation of the observation region from the at least two viewing points; and
processing the at least two 2D views of the 3D representation of the observation region by superimposing each of the at least two 2D views of the 3D representation on the at least one 2D image.

2. The method of claim 1, wherein defining at least two viewing points of the observation region comprising:
defining a front viewing point and a back viewing point based on a placement of the observation region of the object between a source and a receiver of the imaging device;
wherein the front viewing point corresponds to the side of the observation region on which the receiver is positioned; and
wherein the back viewing point corresponds to the side of the observation region on which the source is positioned.

3. The method of claim 2, wherein the acquisition geometry is conical in shape and comprises an axis of revolution with a focal point defining a projective geometry of the at least one 2D image and a sensor plane at which the at least one 2D image is formed;
wherein the back viewing point is positioned on the focal point of the axis of revolution; and
wherein the front viewing point is positioned on the axis of revolution at the sensor plane.

4. The method of claim 2, further comprising:
obtaining a back 2D view of the 3D representation from the back viewing point; and
determining a front 2D view of the 3D representation by inverting coordinates of the back 2D view of the 3D representation.

5. A system for capturing an image of at least an observation region of an object, the system comprising:
an imaging device configured to obtain at least one 2D image of the observation region;
at least one memory unit coupled with the imaging device wherein the at least one memory unit is configured to store at least one previously acquired 3D representation; and
a processing unit coupled to the at least one memory unit wherein the processing unit is configured to;
define at least two viewing points of the observation region;
obtain at least two 2D views of the 3D representation of the observation region from the at least two viewing points; and
superimpose each of the at least two 2D views on the at least one 2D image.

6. The system of claim 5, wherein the processing unit is further configured to define at least two viewing points of the observation region, wherein the at least two viewing points comprise a front viewing point and a back viewing point.

7. The system of claim 6, wherein the processing unit is configured to determine a back 2D view of the observation region from the back viewing point and further configured to determine a front 2D view of the observation region by inverting coordinates of the back 2D view of the 3D representation.
